(19) United States
(12) Patent Application Publication
(10) Pub. No.: US 2004/0041065 A1
(43) Pub. Date: Mar. 4, 2004

(54) Clamping device

(76) Inventor: Renny Tse-Haw Ling, Chung-Ho City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/236,811

(22) Filed: Sep. 4, 2002

(51) Int. Cl. F16B 1/00

(52) U.S. Cl. 248/230.1

(57) ABSTRACT

A clamping device which includes a main body and an insertion member which are separable from each other. The main body has a slot extending along a first direction along which the insertion member is adapted to be inserted thereinto. A at least one positioning latch provided on the main body is used to lock the Insertion member so that the main body and the insertion member become relatively stationary. The main body and insertion member locked by the positioning latch may be released by a release member provided on the main body upon an external force exerted along a second direction. The second direction of the external force exerted on the release member is substantially parallel with the first direction for removing the insertion member out of the slot, such that the separation between the release member and the main body is easily operated.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention is generally related to a clamping device which can be used on a bicycle frame or similar structure for connecting an accessory thereto. In addition, the clamping device of this invention can be quickly detached.

2. Description of the Related Art

The technique for connecting two or more pieces of articles is widely used in existing products. For bicycles, various connecting devices have been developed for securing accessories such as mileage meter, luggage, lock, etc. on the bicycle frame. For example, U.S. Pat. No. 5,474,270 issued to Rixen et al., U.S. Pat. No. 5,718,134 issued to Chang, U.S. Pat. No. 5,785,289 issued to Shieh, and U.S. Pat. No. 6,321,961 issued to McDaid et al. have disclosed related techniques.

All of the techniques disclosed in the above patents may be applied to bicycles by providing a lock or similar device to affix the accessories onto a bicycle. However, among these patents, U.S. Pat. No. 5,474,270 specifically discloses a clamping device with compact structure to enable quick attachment and detachment of two articles. It primarily comprises two detachable components. Each of these two components may be connected with different articles respectively, and these two detachable components may be further engaged by latching such that they are indirectly fixed together.

More specifically, in U.S. Pat. No. 5,474,270, a linear slot is provided on one of the two components and the slot has at least one opening; the other component has an extended anchor which may be inserted into the slot through the opening such that the two components are engaged. Further, the component with the slot also includes a retaining bar which is adapted to lock with the anchor slid into the groove, thus the two components are engaged and fixed, The retaining bar can be resiliently deformed or moved upon an external force such that the engagement between the anchor and the slot may be released and the anchor may be slid out of the slot.

As illustrated in the preferred embodiment of this patent, the retaining bar has a pair of handles at the both ends thereof, and the user must apply a force to at least one of the two handles in order to deflect the middle section of the retaining bar for releasing the engagement between the retaining bar and another component. It can also be found that the extending direction of the retaining bar is perpendicular to the extending direction of the slot and therefore, the direction of the external force to be exerted on the handles is different from the direction for removing the anchor out of the slot. In other words, the user must apply both hands, of which one is used to force the handles for releasing the engagement between the retaining bar and the anchor, and the other must be used to remove the anchor out of the slot, such that the two components may be detached. Strictly speaking, such kind of operation is inconvenient and further improvements thereon are required.

### BRIEF SUMMARY OF THE INVENTION

A primary objective of this invention is to overcome the above disadvantages and provide a latching mechanism such that two separable articles can be assembled thereby. As compared with the conventional techniques, the operation of this invention is easier and faster.

According to this objective, this invention provides a clamping device comprising an insertion member, a main body and a release member. The main body has a slot extending along a first direction into which the insertion member is adapted to be inserted. The main body also has at least one positioning latch having a projection thereon, wherein the projection is adapted to be inserted into at least one notch of the insertion member for positioning when the insertion member is inserted into the slot. The release member is operatively connected with the main body and is adapted to be moved along a second direction upon an external force thereon such that the projection is removed from the at least one notch for removing the insertion member out of the slot in a direction opposite to the first direction. The second direction for the external force exerted on the release member is substantially parallel with the opposite first direction for removing the insertion member out of the slot.

The structures and characteristics of this invention can be realized by referring to the appended drawings and explanations of the preferred embodiments.

### BRIEF DESCRIPTION OF THE SEVERAL VIEWS OF THE DRAWINGS

FIG. 1 is a schematic view showing the structure of a preferred embodiment of the clamping device of this invention which is applied to a bicycle frame for carrying an accessory;

FIG. 2 is an exploded view showing the structure of the clamping device according to the preferred embodiment of this invention;

FIG. 3 is a schematic perspective view showing the clamping device according to the preferred embodiment of this invention;

FIG. 4A is a schematic planar view showing the operation process of the clamping device illustrated in FIG. 3;

FIG. 4B is another schematic planar view showing the operation process of the clamping device illustrated in FIG. 3;

FIG. 4C is a schematic planar view showing the assembled structure of the clamping device illustrated in FIG. 3;

FIG. 4D shows the clamping device of FIG. 4C in which the release member is forced to trigger the positioning latch;

FIG. 5A shows another preferred embodiment of the clamping device according to this invention;

FIG. 5B shows the clamping device of FIG. 5A in which the release member is forced to trigger the positioning latch;

FIG. 6A shows yet another preferred embodiment of the clamping device according to this invention;

FIG. 6B shows the clamping device of FIG. 6A in which the release member is forced to trigger the positioning latch;

FIG. 7A shows a further preferred embodiment of the clamping device according to this invention;

FIG. 7B shows the clamping device of FIG. 7A in which the release member is forced to trigger the positioning latch;

FIG. 8A shows a further preferred embodiment of the clamping device according to this invention;

FIG. 8B shows the clamping device of FIG. 8A in which the release member is forced to trigger the positioning latch;

FIG. 9A shows the other preferred embodiment of the clamping device according to this invention; and

FIG. 9B shows the clamping device of FIG. 9A in which the release member is forced to trigger the positioning latch.

### DETAILED DESCRIPTION OF THE INVENTION

This invention is related to a clamping device which is adapted to connect two pieces of articles. For example, it can be used on a bicycle frame for fast and easy attachment and detachment of accessories such as lock, mileage meter, drink bottle, basket, bag, etc.

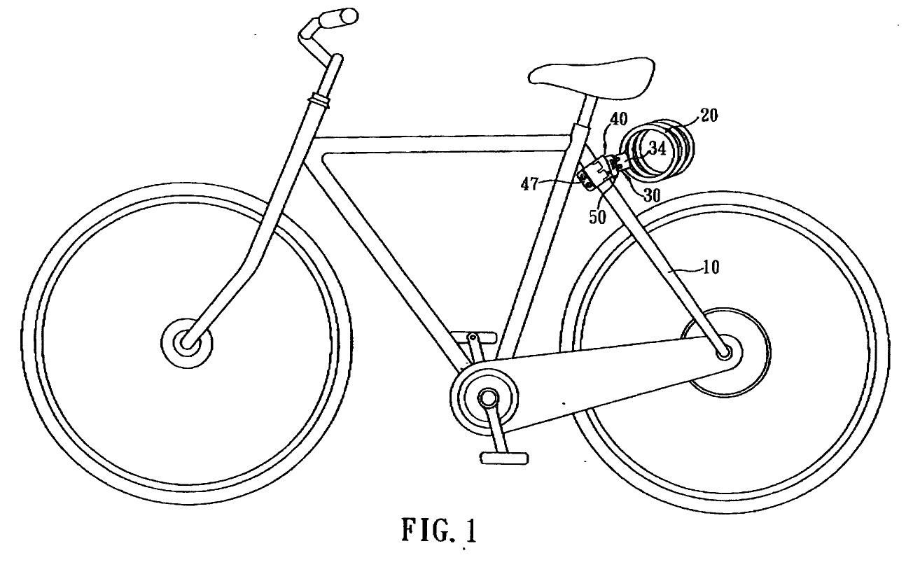

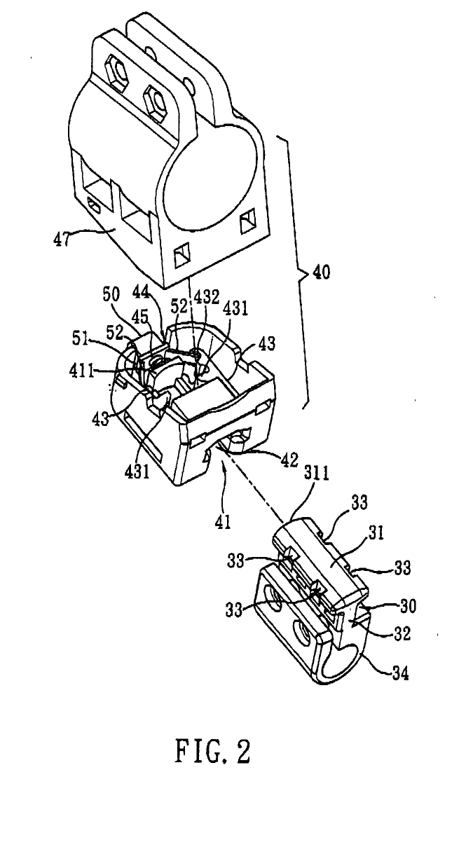

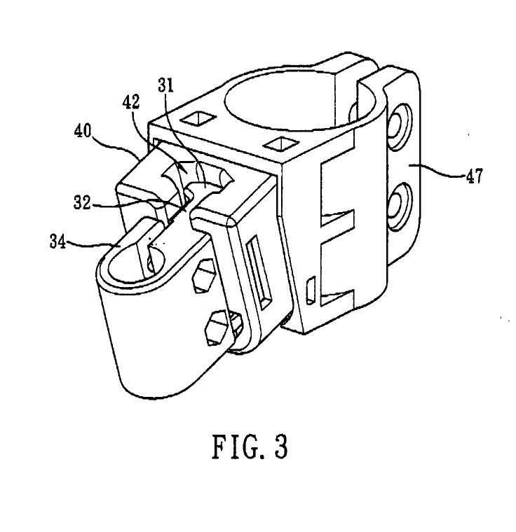

As illustrated in FIG. 1, basically, the clamping device according to this invention has two essential components which are adapted to be connected respectively to two pieces of articles, such as a bicycle frame 10 and a lock 20 respectively, and the two components can be attached. As shown in FIGS. 2 and 3, the two components are an insertion member 30 and a main body 40, of which the insertion member 30 has a relatively narrow neck portion 32 and a head portion 31 extended therefrom, forming a shape similar to that of an anchor. At least one notch 33 is provided on the exterior surface of the head portion 31. The notches 33 may be provided at the locations having substantially the same distance away from the two ends of the head portion 31, such as the two notches 33 on each side of the head portion 31 shown in the figures, or only one notch 33 (not shown) at the middle along each side of the head portion 31.

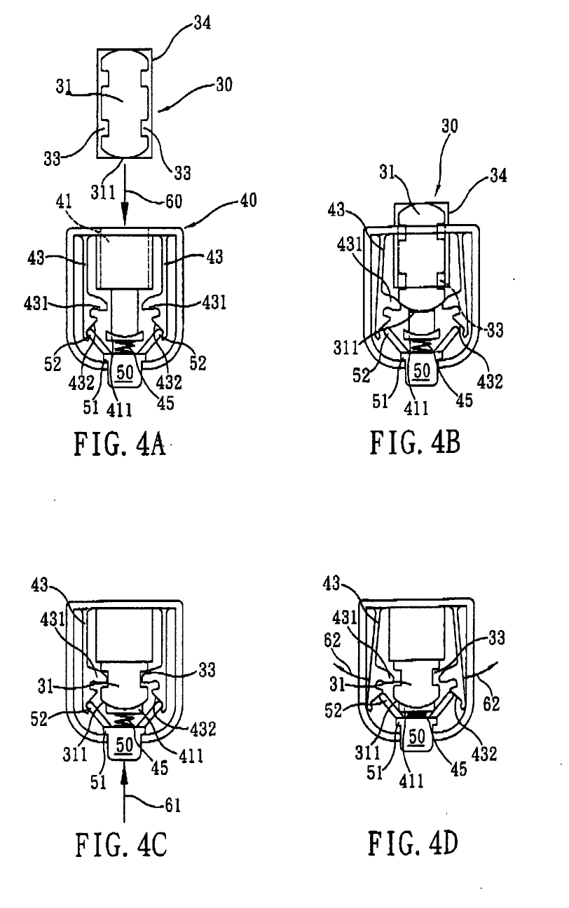

The main body 40 has a generally box-type appearance. One side of the main body 40 is provided with a slot 41 having a cross section with the shape corresponding to that of the insertion member 30. Thus, the head portion 31 and the neck portion 32 of the insertion member 30 are adapted to be inserted into or removed from the opening 42 of the slot 41 along its extending direction, such as the first direction indicated by arrow 60 in FIG. 4A. The insertion member 30 thereby cannot be transversely inserted into or removed from the slot 41. At least one positioning latch 43 is provided beside the slot 41 and is extended from an end of the main body 40. The positioning latch 43 is elongated with a free end and is made by resilient materials to provide flexible property. Thus, the positioning latch 43 may be deflected or deformed by an external force, and it will resume to the original shape and position after the external force is removed. Each of the positioning latches 43 has a projection 431 extending toward the slot 41 at the position close to the free end of the positioning latch 43. The projection 431 is adapted to be inserted into the notch 33 when the insertion member 30 is inserted into the slot 41 (to be further described later), such that the insertion member 30 and the main body 40 are engaged and cannot be released.

When the insertion member 30 is slid into the slot 41 by the external force, the head portion 31 will touch the projections 431 and the insertion member 30 will force the projections 431 transversely deflected, such as that shown in FIG. 4B, so that the head portion 31 may continue to be slid until reaching a stopping block 411. Such a motion is possible because the head portion 31 of the insertion member 30 has an arcuate edge 311 at the end thereof, and the corresponding surface at the projections 431 is inclined or arcuate. Accordingly, when the head portion 31 touches the projections 431, it may force the projections 431 to deflect or deform, so that the insertion member 30 may be further slid along the slot 41. Because the projections 431 are flexible, they can be further deflected and keep in contact with the head portion 31 as it is slid by the external force, until the notches 33 reach the positions of the projections 431. The projections 431 are thus inserted into the notches 33 by the resilient recovery force, as shown in FIG. 4C. At this time, unless the positioning latches 43 are forced such that the projections 431 are moved away from the notches 33, the insertion member 30 and the main body 40 will continue to be in attachment.

In order to release the attachment between the insertion member 30 and the main body 40 for removing the insertion member 30 out of the slot 41, a release member 50 is provided on the main body 40 in the current preferred embodiment. The release member 50 is adapted to trigger the positioning latch 43 by an external force thereupon. The release member 50 is operatively connected with the main body 40 and is used to trigger the positioning latch 43 when the external force is exerted on the release member 50, such that the projections 431 is removed from the notches 33. In the current preferred embodiment, as shown in FIG. 2, the release member 50 is installed through a hole 44 of the main body 40 and is adapted to be moved along a second direction defined by the hole 44. The release member 50 further comprises a shoulder portion 51 at the side within the main body 40 and the shoulder portion 51 is larger than the diameter of the hole 44 and thus, the release member 50 is partially exposed outside the main body but cannot be slid out of the main body 40 through the hole 44, The release member 50 further has at least one arm 52 extending toward the positioning latch 43. When the release member 50 is moved by the external force, the arms 52 trigger the positioning latches 43 for releasing the insertion member 30. More specifically, as the release member 50 is exerted by the external force and moved from a first position, such as that shown in FIG. 4C, to a second position, such as that shown in FIG. 4D, along a predetermined path, such as a second direction indicated by arrow 61, the arms 52 push the positioning latches 43. Accordingly, the positioning latches 43 deflect along the direction indicated by arrows 62, such that the projections 431 are moved out of the notches. Consequently, the insertion member 30 is no longer engaged with the main body 40 and can be freely removed from the slot 41 and subsequently separated from the main body 40.

The main body 40 further comprises a first resilient member 45, such as a spring or a resilient plate, etc., to provide an outward force on the release member 50, such that the release member 50 remains at the first position and is partially exposed outside the main body 40 when there is no external force. The first resilient member 45 pushes the release member 50 outward so that the shoulder portion 51 keeps resisting against the flange of the hole 44 of the main body 40.

From the above explanation, it can be understood that when the release member 50 is forced along the direction indicated by arrow 61, the release member 50 triggers the positioning latches 43 to remove their restriction on the insertion member 30 which can thereby be slid out of the slot 41 along the same direction with arrow 61. Accordingly, the user only needs to push the release member 50 to release the engagement between the positioning latches 43 and the insertion member 30, the release member 30 can be slid out of the slot 41 along the same direction right away. Thus, the clamping device according to this invention is a device which can be operated by one hand only.

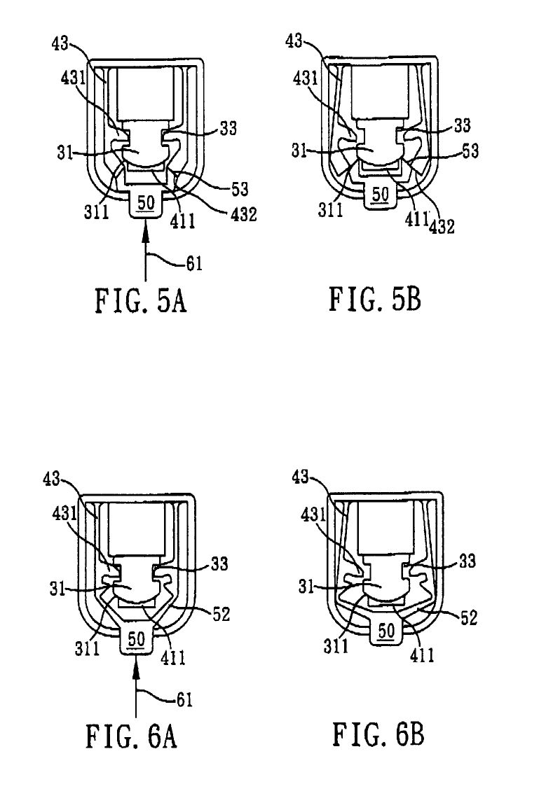

According to the technique disclosed in this invention, the release member 50 uses the arms 52 to trigger the positioning latches 43 at the inclined surface thereof. In the preferred embodiments, the positioning latch 43 may have a first inclined guiding surface 432 to be pushed by the arm 52, as shown in FIG. 4A. Alternatively, the release member 50 may also have a second inclined guiding surface 53 corresponding to the first inclined guiding surface 432, as shown in FIGS. 5A and 5B. Moreover, the release member 50 and the positioning latches 43 may also be integrally structured, as shown in FIGS. 6A and 6B.

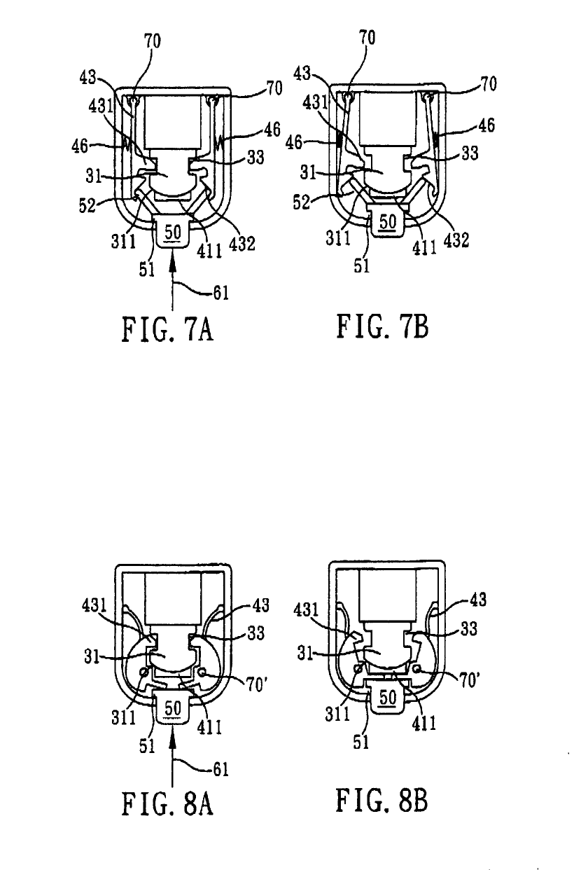

On the other hand, the positioning latches 43 may not be directly connected with the main body 40, and may not be made of resilient materials. As shown in FIG. 7A, the positioning latches 43 may be mounted on the main body 40 through the pivotal axles 70, or, as shown in FIG. 8A, the positioning latches 43 are further connected with pivotal axles 70′. Accordingly, the positioning latches 43 can be pivotally rotated or moved with respect to the main body 40, such that the projections 431 can be moved into or out of the notches 33 of the insertion member 30. However, this kind of design needs additional external force to be exerted on the positioning latches 43 which thereby remain at the position that the projections 431 are inserted into the notches 33. For example, as shown in FIGS. 7A and 7B, second resilient members 46 are mounted on the main body 40 to push the positioning latches 43.

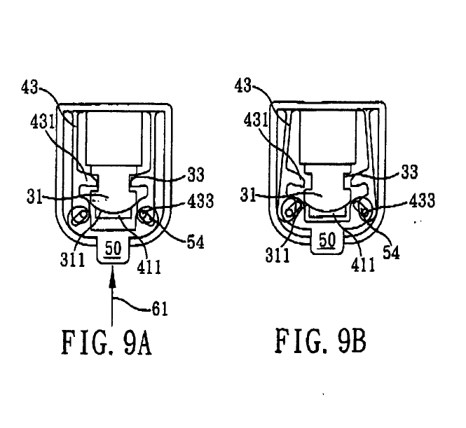

Further, the release member 50 and the positioning latches 43 may be constructed as that shown in FIGS. 9A and 9B according to similar principle of the inclined guiding surface. In this embodiment, the release member 50 has. slant holes 54 while each of the positioning latches 43 has a directing post 433 extending through the slant hole 54, such that the slant holes 54 force the directing posts 433, as well as the positioning latches 43, to be moved when the release member 50 is moved along the predetermined direction by the external force.

All the structural variations disclosed in the above preferred embodiments meet the objective and technique of this invention. As can be seen in FIGS. 4C, 4D, 5A, 5B, 6A, 6B, 7A, 7B, 8A, 8B, 9A and 9B, the direction of the force to be exerted on the release member 50 in each embodiments, as indicated by arrow 61, is parallel with the direction for removing the insertion member 30 out of the slot 41.

Even though the structural design of each of the above preferred embodiments involves slight variation, the basic technique of this invention involved therein remains the same. That is, the engagement between the positioning latches 43 and the insertion member 30 may be released when the release member 50 provided on the main body 40 is subject to the external force. The first resilient member 45 may be provided in various embodiments to provide an outward force on the release member 50, such that the release member 50 remains at the first position and is partially exposed outside the main body 40 when there is no external force. In addition, the direction of the force to be exerted on the release member 50 is parallel with the direction for removing the insertion member 30 out of the slot 41 and thus, the disengagement operation of the insertion member 30 and the main body 40 is much easier and faster.

In conclusion, the primary objective of this invention is to provide a clamping device with latching mechanism such that two separable articles can be assembled thereby. As compared with the conventional technique, the operation of this invention is easier and faster.

According to this invention, the main body 40 and the insertion member 30 may further include a connection portion 47 and 34, respectively, as shown in FIG. 2, so as to connect two separated articles, such as the bicycle frame 10 and the lock 20 shown in FIG. 1. As a result, the bicycle frame 10 and the accessories such as the lock 20 can be attached or detached quickly and easily.

This invention is related to a novel creation which makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

Sequence Listing

| | |
|---|---|
| 10 | bicycle frame |
| 20 | lock |
| 30 | Insertion member |
| 31 | head portion |
| 311 | arcuate edge |
| 32 | neck portion |
| 33 | notches |
| 34 | connection portion |
| 40 | main body |
| 41 | slot |
| 411 | stopping block |
| 42 | opening |
| 43 | positioning latch |
| 431 | projections |
| 432 | first inclined guiding surfaces |
| 433 | directing posts |
| 44 | hole |
| 45 | first resilient member |
| 46 | second resilient member |
| 47 | connection portion |
| 50 | release member |
| 51 | shoulder portion |
| 52 | arms |
| 53 | second inclined guiding surfaces |
| 54 | slant holes |
| 60 | arrow |
| 61 | arrow |
| 62 | arrows |
| 70 | pivotal axles |
| 70′ | pivotal axles |

1. A clamping device, comprising:
an insertion member having an exterior surface with at least one notch thereon;
a main body having a slot extending along a first direction, wherein the insertion member is adapted to be Inserted into the slot along the first direction;
at least one positioning latch which is connected with the main body and has a projection thereon, wherein the at least one positioning latch is mounted on the main body and is resilient, and the projection is adapted to be inserted into the at least one notch for positioning when the insertion member is inserted into the slot; and
a release member which is operatively connected with the main body and is adapted to be moved along a second direction upon an external force thereon such that the projection is removed from the at least one notch, and the second direction of the release member is substantially parallel with the first direction of the slot.

2. The clamping device according to claim 1, wherein the main body further comprises a first resilient member acting on the release member such that the release member remains at a position extending out of the main body when there is no external force applied on the release member.

3. The clamping device according to claim 1, wherein the at least one positioning latch has a first inclined guiding surface such that the release member is inclinedly moved upon the external force.

4. The clamping device according to claim 3, wherein the release member has a second inclined guiding surface corresponding to the first inclined guiding surface of the at least one positioning latch.

5. The clamping device according to claim 1, wherein each of the at least one positioning latch is connected with the release member.

6. The clamping device according to claim 1, wherein the release member includes slant holes and each of the at least one positioning latch comprises a directing post extending through the slant hole, such that the slant hole forces the directing post to be moved when the release member is moved along the second direction by the external force.

7. The clamping device according to claim 1, wherein each of the insertion member and the main body has a connection portion.

8. The clamping device according to claim 1, wherein the insertion member has two ends and the at least one notch is provided at a location with substantially the same distance away from the two ends.

9. The clamping device according to claim 8, wherein the at least one notch is provided at substantially the middle of the insertion member.

10. A clamping device, comprising:
an insertion member having an exterior surface with at least one notch thereon;
a main body having a slot extending along a first direction, wherein the insertion member is adapted to be inserted into the slot along the first direction, and the main body further comprises a second resilient member;
at least one positioning latch which is connected with the main body and has a projection thereon, wherein the projection is adapted to be inserted into the at least one notch for positioning when the insertion member is inserted into the slot; the at least one positioning latch is pivotally connected with the main body, and the second resilient member acts on the at least one positioning latch; and
a release member which is operatively connected with the main body and is adapted to be moved along a second direction upon an external force thereon such that the projection is removed from the at least one notch, and the second direction of the release member is substantially parallel with the first direction of the slot.

11. The clamping device according to claim 10, wherein the main body further comprises a first resilient member acting on the release member such that the release member remains at a position extending out .of the main body when there is no external force applied on the release member.

12. The clamping device according to claim 10, wherein the at least one positioning latch has a first inclined guiding surface such that the release member is inclinedly moved upon the external force.

13. The clamping device according to claim 12, wherein the release member has a second Inclined guiding surface corresponding to the first inclined guiding surface of the at least one positioning latch.

14. The clamping device according to claim 10, wherein each of the insertion member and the main body has a connection portion.

15. The clamping device according to claim 10, wherein the insertion member has two ends and the at least one notch is provided at a location with substantially the same distance away from the two ends.

16. The clamping device according to claim 15, wherein the at least one notch is provided at substantially the middle of the insertion member.
